(19) United States
(12) Patent Application Publication
(10) Pub. No.: US 2008/0147298 A1
(43) Pub. Date: Jun. 19, 2008

(54) CONTROL SYSTEM AND CONTROL METHOD FOR INTERNAL COMBUSTION ENGINE

(75) Inventors: Shogo Suda, Susono-shi (JP); Nobuhiko Koga, Susono-shi (JP); Nao Murase, Susono-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/945,007

(22) Filed: Nov. 26, 2007

(30) Foreign Application Priority Data
Dec. 18, 2006 (JP) 2006-340360

(51) Int. Cl. F02D 43/00

(52) U.S. Cl. 701/103

(57) ABSTRACT

In an ignition control system for an internal combustion engine which is capable of advancing the ignition timing beyond the MBT, the amount of fuel used for the combustion in a cylinder is made appropriate by performing a decreasing correction of the amount of fuel injection of a fuel injection valve when the ignition timing is advanced beyond the MBT.

### INCORPORATION BY REFERENCE

The disclosure of Japanese Patent Application No. 2006-340360 filed on Dec. 18, 2006 including the specification, drawings and abstract is incorporated herein by reference in its entirety.

### BACKGROUND OF THE INVENTION

1. Field of the Invention

The invention relates to a control system and a control method for a spark ignition type internal combustion engine.

2. Description of the Related Art

In the spark ignition type of internal combustion engine, there is a known technology that advances the ignition timing beyond the MBT (minimum spark advance for the best torque), thereby accelerates the temperature rise of coolant and improves the warming-up characteristic of the internal combustion engine (see, e.g., Japanese Patent Application Publication No. JP-A-2000-240547).

Incidentally, through intensive experiments and verifications, the present inventors have found that if the ignition timing is advanced beyond the MBT, the amount of fuel used for combustion in the cylinder changes.

### SUMMARY OF THE INVENTION

The invention provides a control system and a control method for a spark ignition type internal combustion engine that advances the ignition timing beyond the MBT, and that makes appropriate the amount of fuel used for combustion in the cylinder if the ignition timing is advanced beyond the MBT.

A first aspect of the invention relates to a control system for a spark ignition type internal combustion engine. This control system includes: an over-advancement device that advances an ignition timing of the internal combustion engine beyond an MBT; and a correction device that performs a decreasing control of a fuel injection amount of a fuel injection valve of the internal combustion engine when the ignition timing is advanced beyond the MBT by the over-advancement device.

According to this construction, it does not happen that the contributing-to-combustion fuel becomes excessively large when the ignition timing is advanced beyond the MBT (hereinafter, referred to as “over-advanced”). That is, the contributing-to-combustion fuel when the ignition timing is over-advanced can be made appropriate.

As a result, it becomes possible to improve the fuel economy without decreasing the torque generated by the internal combustion engine. Furthermore, besides the decrease in the in-cylinder fuel deposit amount caused by the over-advancement of the ignition timing, the decrease in the in-cylinder fuel deposit amount caused by decrease in the fuel injection amount can also be expected. The decrease of the in-cylinder fuel deposit amount in this manner makes it possible to decrease the unburned fuel components discharged from the cylinder.

A second aspect of the invention relates to a control method for a spark ignition type internal combustion engine. This control method includes: advancing an ignition timing of the internal combustion engine beyond an MBT; and performing a decreasing control of a fuel injection amount of a fuel injection valve of the internal combustion engine when the ignition timing is advanced beyond the MBT.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic diagram showing a construction of a control system for an internal combustion engine in accordance with an embodiment of the invention;

FIG. 2 is a diagram showing a relationship between the unburned fuel (HC), which is discharged from a cylinder, and the ignition timing;

FIG. 3 is a diagram showing a relationship between the ignition timing and the state inside the cylinder;

FIG. 4 is a diagram showing a relationship between the ignition timing and the air-fuel ratio of exhaust gas;

FIG. 5 is a timing chart showing an execution procedure of a fuel deposit reduction control in a first embodiment of the invention;

FIG. 6 is a flowchart showing a fuel injection amount correction routine performed during the execution of the fuel deposit reduction control in the first embodiment of the invention;

FIG. 7 is a diagram showing a relationship between the ignition timing and the amount of fuel deposit that can be removed at the ignition timing;

FIG. 8 is a diagram showing proportions of the contributing-to-combustion fuel, the in-cylinder fuel deposit, and the port fuel deposit;

FIG. 9 is a timing chart showing an execution procedure of the fuel deposit reduction control in a second embodiment of the invention;

FIG. 10 is a flowchart showing the fuel injection amount correction routine when the fuel deposit reduction control is executed in the second embodiment of the invention;

FIG. 11 is a first timing chart showing another execution procedure of the fuel deposit reduction control in the second embodiment; and

FIG. 12 is a second timing chart showing another execution procedure of the fuel deposit reduction control in the second embodiment.

### DETAILED DESCRIPTION OF THE EMBODIMENTS

Hereinafter, concrete embodiments of the invention will be described with reference to the drawings.

### First Embodiment

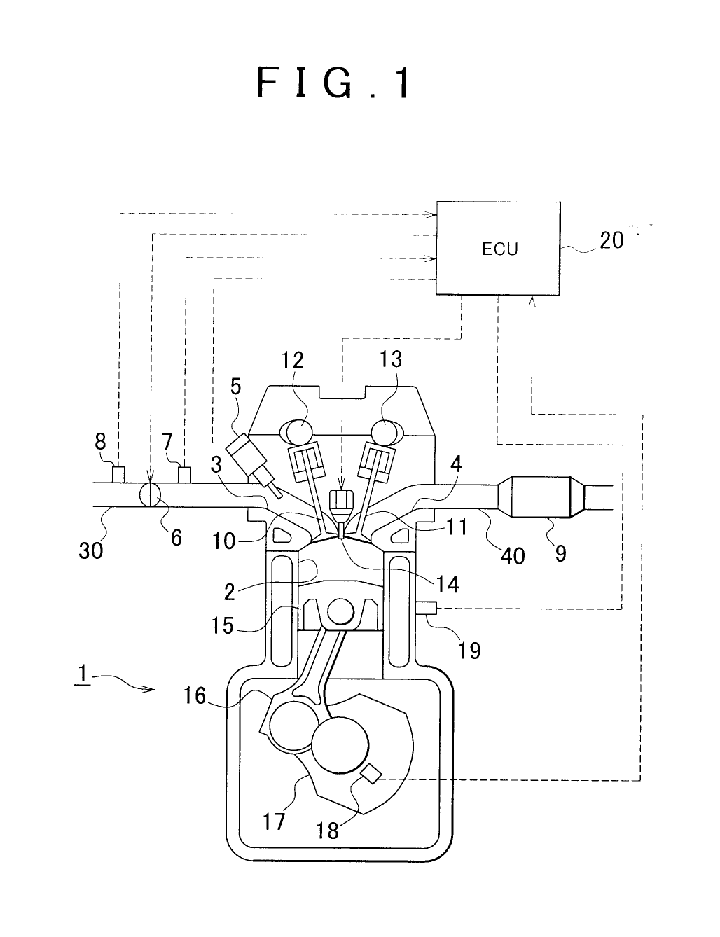

Firstly, a first embodiment of the invention will be described with reference to FIGS. 1 to 7. FIG. 1 is a schematic diagram showing a construction of a control system for an internal combustion engine in accordance with the first embodiment of the invention.

An internal combustion engine 1 shown in FIG. 1 is a spark ignition type four-stroke internal combustion engine (gasoline engine) having a plurality of cylinders 2. The cylinders 2 of the internal combustion engine 1 are connected to an intake passage 30 via intake ports 3, and are connected to an exhaust passage 40 via exhaust ports 4.

Each intake port 3 is provided with a fuel injection valve 5 that injects fuel into a corresponding one of the cylinders 2. The intake passage 30 is provided with a throttle valve 6 that controls the amount of air that passes in the intake passage 30. The intake passage 30 downstream of the throttle valve 6 is provided with an intake air pressure sensor 7 that measures the pressure in the intake passage 30 (intake air pressure). The intake passage 30 upstream of the throttle valve 6 is provided with an air flow meter 8 that measures the amount of air that flows in the intake passage 30.

On the other hand, the exhaust passage 40 is provided with an exhaust gas purification device 9. The exhaust gas purification device 9 is equipped with a three-way catalyst, a storage reduction type NOx catalyst, etc., and purifies exhaust gas when in a predetermined activation temperature range.

Besides, the internal combustion engine 1 is also provided with intake valves 10 each of which opens and closes the opening end of a corresponding one of the intake ports 3 facing the interiors of the cylinders 2, and exhaust valves 11 each of which opens and closes the opening end of a corresponding one of the exhaust ports 4 facing the interior of the cylinders 2. The intake valves 10 and the exhaust valves 11 are driven to open and close by an intake-side camshaft 12 and an exhaust-side camshaft 13, respectively.

An upper portion of each cylinder 2 is provided with an ignition plug 14 that ignites a mixture in the cylinder 2. A piston 15 is placed slidably in the cylinder 2. The pistons 15 are connected to a crankshaft 17 via connecting rods 16.

Near the crankshaft 17, there is disposed a crank position sensor 18 that detects the rotation angle of the crankshaft 17. Furthermore, the internal combustion engine 1 is provided with a water temperature sensor 19 that measures the temperature of coolant that circulates in the internal combustion engine 1.

The internal combustion engine 1 constructed as described above is provided with an ECU 20. The ECU 20 is an electronic control unit that includes a CPU, a ROM, a RAM, etc. The ECU 20 is electrically connected to various sensors, including the intake air pressure sensor 7, the air flow meter 8, the crank position sensor 18, the water temperature sensor 19, etc., and is capable of receiving inputs of values measured by the various sensors.

The ECU 20 electrically controls the fuel injection valves 5, the throttle valve 6 and the ignition plugs 14 on the basis of the measurement values from the various sensors. For example, the ECU 20 performs a fuel deposit reduction control of reducing the fuel that deposits on the wall surface inside each cylinder 2 (the in-cylinder fuel deposit).

Hereinafter, the fuel deposit reduction control in this embodiment will be described.

When the in-cylinder temperature is low, for example, when the internal combustion engine 1 is in a cold state, fuel is liable to deposit on the wall surface inside each cylinder. Most of the fuel deposited on the wall surface inside each cylinder (the in-cylinder fuel deposit) is discharged unburned without being used for combustion. In that situation, if the temperature of the exhaust gas purification device 9 has not risen to the activation temperature range, the unburned fuel is emitted into the atmosphere without being removed.

In particular, in the case where the internal combustion engine 1 is started at very low temperature, and the like, the period from the startup of the internal combustion engine 1 until the exhaust gas purification device 9 activates becomes long and therefore the in-cylinder fuel deposit amount increases. In such cases, therefore, there is possibility of an excessive amount of unburned fuel being emitted into the atmosphere.

Therefore, in the fuel deposit reduction control, the ECU 20 reduces the in-cylinder fuel deposit by advancing the activation timing of the ignition plugs 14 (the ignition timing) beyond the MBT when the in-cylinder fuel deposit is liable to increase.

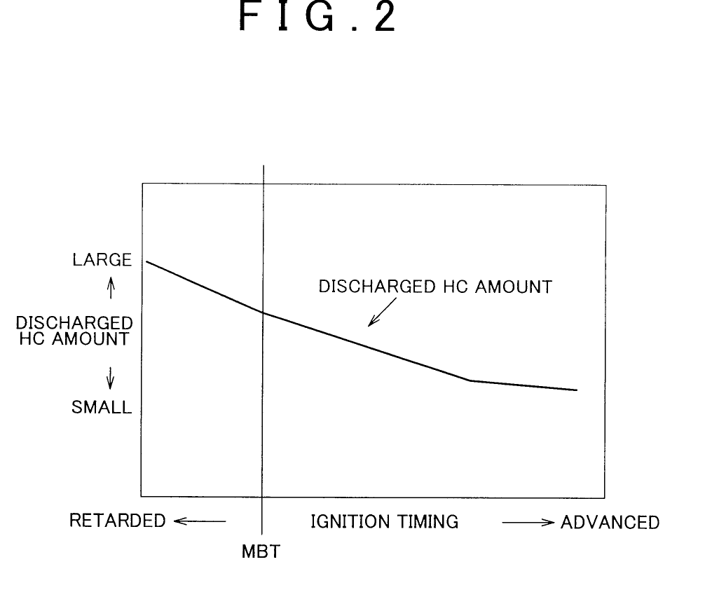

The inventors' intensive experiments and verifications have elucidated that in the case where the ignition timing is advanced beyond the MBT, the larger the timing advancement, the smaller the amount of unburned fuel (HC) discharged from each cylinder 2, as shown in FIG. 2.

The mechanism of this phenomenon has not been completely elucidated, but is approximately considered to be as follows.

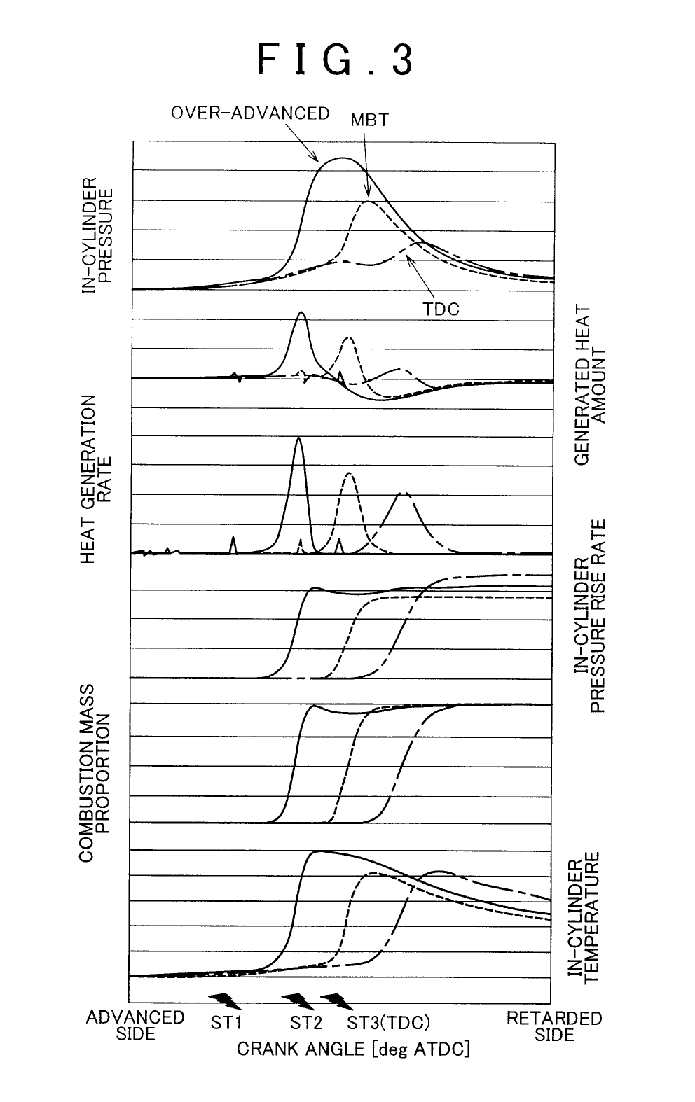

FIG. 3 is a diagram showing results of the measurement of the state in a cylinder 2 in the case where the ignition timing is advanced beyond the MBT (hereinafter, referred to as “over-advanced”) (ST1 in FIG. 3), the case where the ignition timing is set at the MBT (ST2 in FIG. 3), and the case where the ignition timing is set at the compression top dead center (TDC) (ST3 in FIG. 3). In FIG. 3, solid lines show the case where the ignition timing is over-advanced, and dashed lines show the case where the ignition timing is set at the MBT, and one-dot dashed lines show the case where the ignition timing is set at the compression top dead center (TDC).

In FIG. 3, in the case where the ignition timing is over-advanced, the amount of the mixture burned prior to the compression top dead center is larger than in the case where the ignition timing set at the MBT and the case where the ignition timing is set at the compression top dead center (TDC). Therefore, in the case of the over-advancement, the peak of the heat energy generated by the combustion of mixture (see the heat generation rate, the generated heat amount, and the combustion mass proportion in FIG. 3) shifts to the advanced side of the compression top dead center.

Therefore, due to a synergetic effect of the temperature and pressure raising effect caused by the combustion of mixture and the compression effect caused by the ascending movement of the piston (the movement from the bottom dead center toward the top dead center), the peak values of the in-cylinder pressure and the in-cylinder temperature during the period from the compression stroke to the expansion stroke greatly rise. It is considered that as a result, the in-cylinder fuel deposit vaporizes and/or fuel vaporizes and is used for combustion before depositing on the wall surface inside the cylinder.

Therefore, when the in-cylinder fuel deposit amount is expected to increase, the ECU 20 over-advances the ignition timing. Examples of the case where the in-cylinder fuel deposit amount is expected to increase include the case where the internal combustion engine 1 is in a cold start state, the case where the internal combustion engine 1 is in an warming-up operation state, the case where the actually measured value of the in-cylinder fuel deposit amount exceeds a permissible amount, the case where an estimated value of the in-cylinder fuel deposit amount exceeds a permissible amount, etc.

Examples of the actual measurement method for the in-cylinder fuel deposit amount include a method in which a sensor that optically measures the thickness of a liquid film is disposed in the cylinder 2, and a method in which a sensor that measures electroconductivity is disposed in the cylinder 2 and the value measured by the sensor is converted into an in-cylinder fuel deposit amount. Examples of the method of estimating the in-cylinder fuel deposit amount include a method in which the in-cylinder fuel deposit amount is estimated from a correlation between the in-cylinder fuel deposit amount and at least one of the coolant temperature, the cumulative fuel injection amount from the time of startup of the engine, the cumulative intake air amount from the time of startup of the engine, the fuel injection amount, the intake air pressure and the air-fuel ratio.

If the ignition timing of the ignition plug 14 is over-advanced when the in-cylinder fuel deposit amount is expected to become large, it becomes possible to decrease the in-cylinder fuel deposit and also decrease the unburned fuel discharged from the cylinder 2.

Incidentally, if the over-advancement of the ignition timing as described above is performed, the in-cylinder fuel deposit decreases and, in conjunction with that, the fuel used for the combustion in each cylinder 2 (contributing-to-combustion fuel) increases. In a related-art fuel injection control, the fuel injection amount is subjected to an increasing correction (hereinafter, referred to as “in-cylinder fuel deposit correction”) in expectation of the next amount of in-cylinder fuel deposit. Therefore, if the contributing-to-combustion fuel is increased as described above, the air-fuel ratio of exhaust gas can possibly deviate from the predetermined air-fuel ratio, or the torque generated by the internal combustion engine 1 can possibly deviate from target torque.

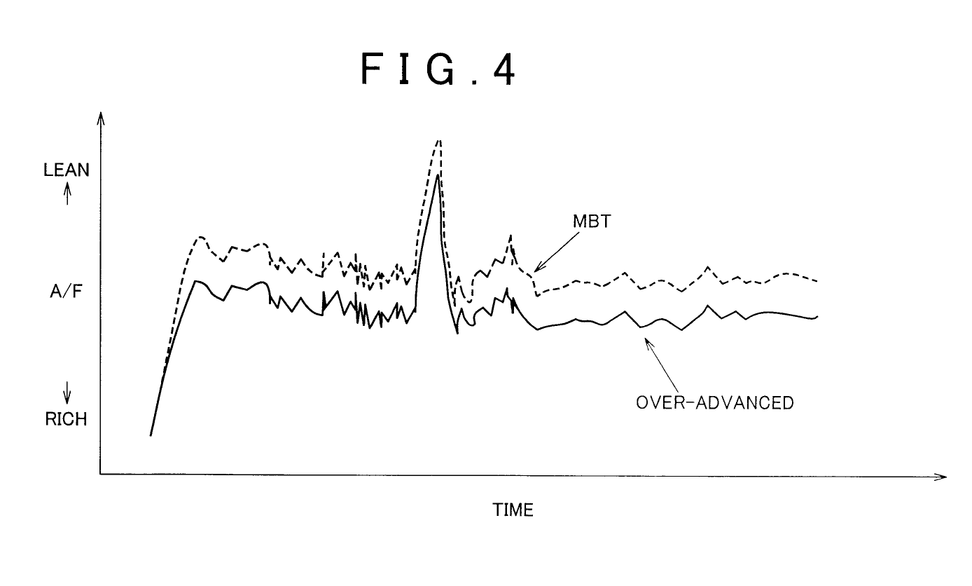

FIG. 4 is a diagram showing results of the measurement of the air-fuel ratio (A/F) of exhaust gas discharged from the cylinder 2 when the ignition timing is over-advanced and when the ignition timing is set at the MBT. Incidentally, the results of the two measurement cases shown in FIG. 4 are results of the measurement performed where the operation conditions other than the ignition timing are the same between the two cases.

In FIG. 4, the air-fuel ratio A/F is lower (richer) when the ignition timing is over-advanced than when the ignition timing is set at the MBT. According to these measurement results, it can be said that the contributing-to-combustion fuel amount is larger when the ignition timing is over-advanced than when the ignition timing is set at the MBT.

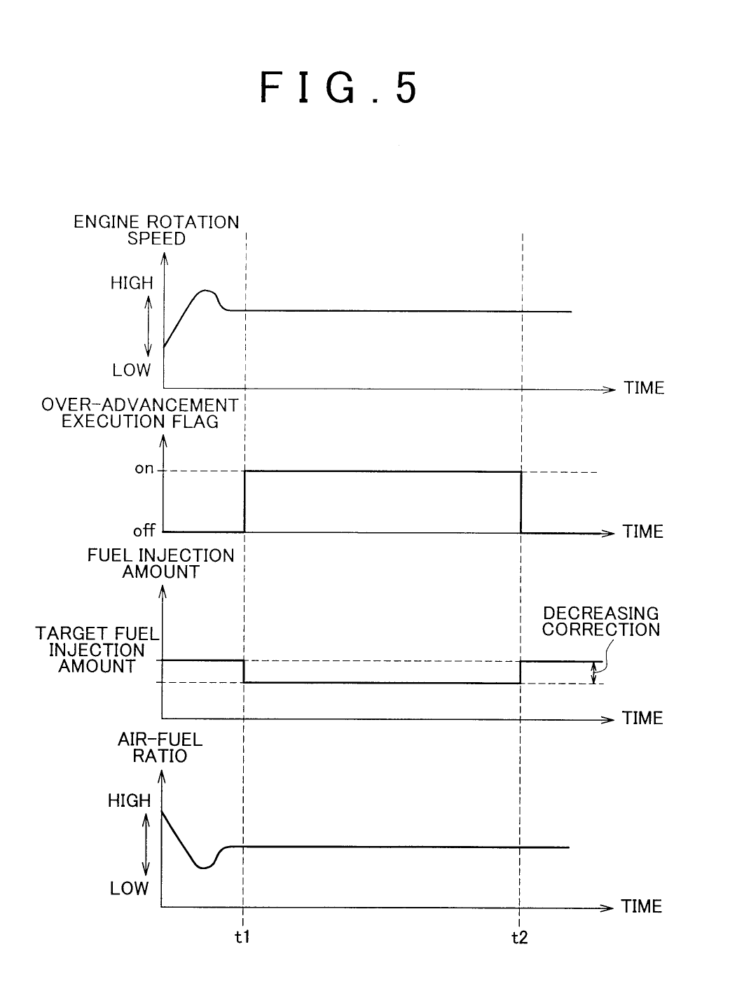

Therefore, in the fuel deposit reduction control of this embodiment, the ECU 20 performs a decreasing correction of a target fuel injection amount of the fuel injection valve 5 when the ignition timing has been over-advanced (when an over-advancement execution flag mentioned in FIG. 5 is on), as shown in FIG. 5. That is, the ECU 20 starts the decreasing correction of the target fuel injection amount when the over-advancement of the ignition timing is started (t1 in FIG. 5), and the ECU 20 ends the decreasing correction of the target fuel injection amount when the over-advancement of the ignition timing is ended (t2 in FIG. 5).

Thus, if the decreasing correction of the target fuel injection amount is performed during the period of the state of the over-advancement of the ignition timing (the period of t1 to t2 in FIG. 5), the contributing-to-combustion fuel amount does not change between before and after the start of the execution of the over-advancement nor between before and after the end of the execution thereof. As a result, the air-fuel ratio of the exhaust gas discharged from the cylinder 2 also does not change between before and after the start of the execution of the over-advancement nor between before and after the end of the execution thereof.

Therefore, according to the fuel deposit reduction control of this embodiment, the unburned fuel components discharged from each cylinder 2 can be decreased by the over-advancement of the ignition timing, and the fluctuation of the air-fuel ratio and the fluctuation of the torque caused by the over-advancement of the ignition timing by the decreasing correction of the fuel injection amount. Furthermore, if the decreasing correction of the fuel injection amount is performed simultaneously with the over-advancement of the ignition timing, it becomes possible to improve the fuel economy without decreasing the torque generated by the internal combustion engine 1. Still further, besides the decrease in the in-cylinder fuel deposit amount caused by the over-advancement of the ignition timing, the decrease in the in-cylinder fuel deposit amount caused by decrease in the fuel injection amount can also be expected. Therefore, the unburned fuel components discharged from each cylinder 2 can be further lessened.

Examples of the decreasing correction method for the fuel injection amount include: (1) a method in which the in-cylinder fuel deposit correction is set at “0”, (2) a method in which a constant amount is subtracted from the in-cylinder fuel deposit correction amount (or the target fuel injection amount), (3) a method in which the in-cylinder fuel deposit correction amount (or the target fuel injection amount) is changed in accordance with the amount of advancement of the ignition timing (e.g., the in-cylinder fuel deposit correction amount is made smaller the larger the amount of advancement is, since the in-cylinder fuel deposit amount is smaller the more the amount of advancement is), etc.

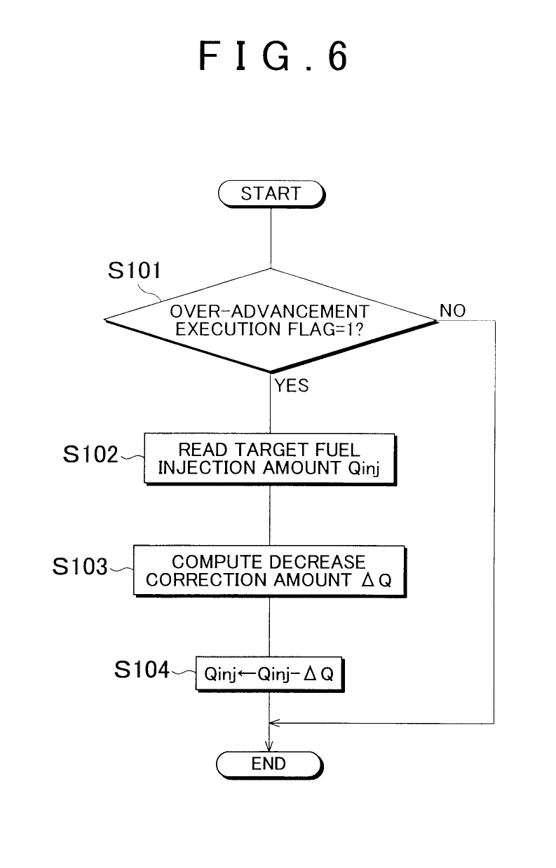

Next, an execution procedure of the fuel deposit reduction control in this embodiment will be described with reference to FIG. 6. FIG. 6 is a flowchart showing a fuel injection amount correction routine performed when the fuel deposit reduction control is executed. This routine is pre-stored in the ROM of the ECU 20, and is periodically executed by the ECU 20. The ECU 20 executing the routine shown in FIG. 6 realizes a correction device in accordance with the invention.

In the routine shown in FIG. 6, in S101, the ECU 20 firstly determines whether the value of the over-advancement execution flag is “1”. The over-advancement execution flag is set at “1” when the in-cylinder fuel deposit amount is expected to become large (i.e., when the over-advancement of the ignition timing is executed), and is reset to “0” when it is expected that the in-cylinder fuel deposit amount will not become large (i.e., when the over-advancement of the ignition timing is not executed).

If a negative determination is made in S101 (the over-advancement execution flag=0), the ECU 20 ends the execution of this routine. On the other hand, if an affirmative determination is made in S101 (the over-advancement execution flag=1), the ECU 20 executes the process of S102.

In S102, the ECU 20 reads a target fuel injection amount Qinj calculated in a fuel injection amount control routine separately executed.

In S103, the ECU 20 computes a decrease correction amount ΔQ. The decrease correction amount ΔQ may be the same amount as the in-cylinder fuel deposit correction amount, or may also be set at the same amount as an actually measured value (or an estimated value) of the in-cylinder fuel deposit amount.

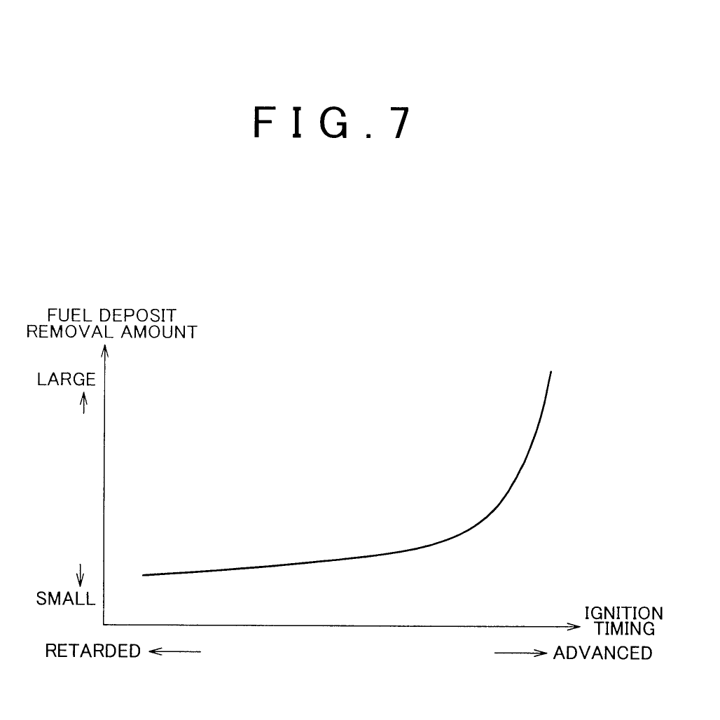

Incidentally, the decrease correction amount ΔQ may also be determined from the over-advanced ignition timing and a map shown in FIG. 7. In the map in FIG. 7, a relationship between the ignition timing and the in-cylinder fuel deposit amount that is removable (by evaporation and combustion) corresponding to the ignition timing (hereinafter, referred to as “fuel deposit removal amount”) is determined. According to the map of FIG. 7, the larger the amount of advancement of the ignition timing (in other words, the more advanced the ignition timing), the larger the fuel deposit removal amount. Hence, the decrease correction amount ΔQ is made larger the larger the amount of advancement of the ignition timing. Incidentally, the relationship between the ignition timing and the fuel deposit removal amount shown in FIG. 7 is determined by experiments beforehand.

Referring back to the routine of FIG. 6, the ECU 20, in S104, subtracts the decrease correction amount ΔQ calculated in S103 from the target fuel injection amount Qinj read in S102, and sets the result of the subtraction (=Qinj−ΔQ) as a target fuel injection amount Qinj. Then, the ECU 20 actuates the fuel injection valve 5 in accordance with the target fuel injection amount Qinj (=Qinj−ΔQ) calculated in S104. Incidentally, although in S104 the decrease correction amount AQ is subtracted from the target fuel injection amount Qinj, the decrease correction amount ΔQ may also be subtracted from the in-cylinder fuel deposit correction amount that is used for the calculation of the target fuel injection amount Qinj.

As the ECU 20 executes the routine of FIG. 6 in this manner, the fuel injection amount during the over-advanced state of the ignition timing is made appropriate, so that the fluctuation in the air-fuel ratio or the torque caused by the execution of the over-advancement is restrained, and therefore the fuel economy at the time of over-advancement of the ignition timing can be improved, and the amount of the unburned fuel components discharged from each cylinder 2 can be decreased.

### Second Embodiment

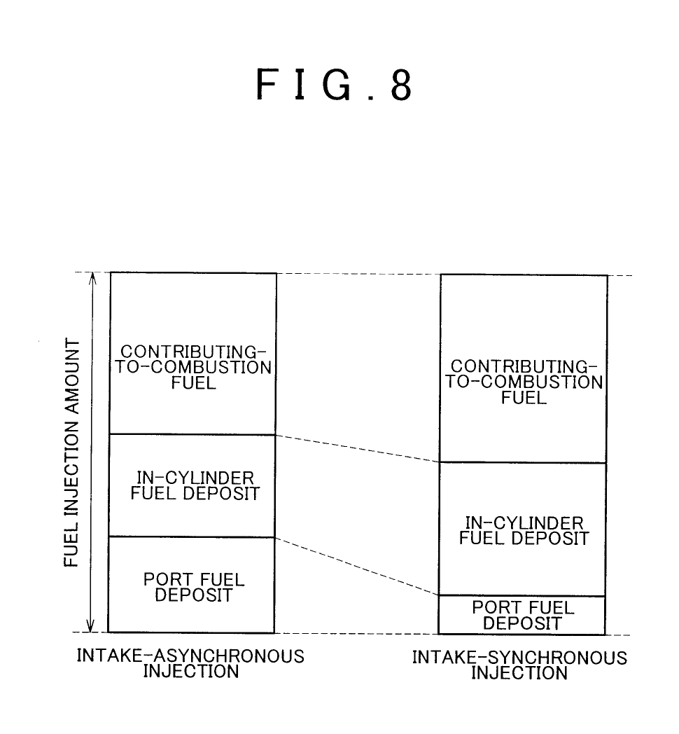

Next, a second embodiment of the control system for an internal combustion engine in accordance with the invention will be described with reference to FIGS. 8 to 12. Constructions of the control system in the second embodiment different from those in the first embodiment will be described, and substantially the same constructions as those in the first embodiment will not be described below.

In the second embodiment, for example, the fuel injection timing is also optimized, in addition to the fuel injection amount, when the ignition timing is over-advanced.

During the startup or the warming-up operation of the internal combustion engine 1, it sometimes happens that the fuel injection timing of each cylinder 2 is set at a timing that is asynchronous with the intake stroke of the cylinder (the intake-asynchronous injection). In that case, much fuel is liable to deposit on the wall surface inside each intake port 3 in addition to the wall surface inside each cylinder 2. There is a possibility that the fuel deposited on the wall surface inside each intake port 3 (the port fuel deposit) may flows without being burned into the exhaust passage 40 during the valve overlap period of the intake and exhaust valves 10, 11. Besides, if the port fuel deposit increases in amount, it becomes necessary to perform an increasing correction of the fuel injection amount that factors in the port fuel deposit in addition to the in-cylinder fuel deposit, and therefore deterioration of the fuel economy becomes a concern.

On the other hand, if the fuel injection timing is set at a timing synchronous with the intake stroke of each cylinder 2 (the intake-synchronous injection), the port fuel deposit decreases in amount as shown in FIG. 8. However, if the port fuel deposit decreases in amount, there arises a possibility of increases in the in-cylinder fuel deposit and the contributing-to-combustion fuel.

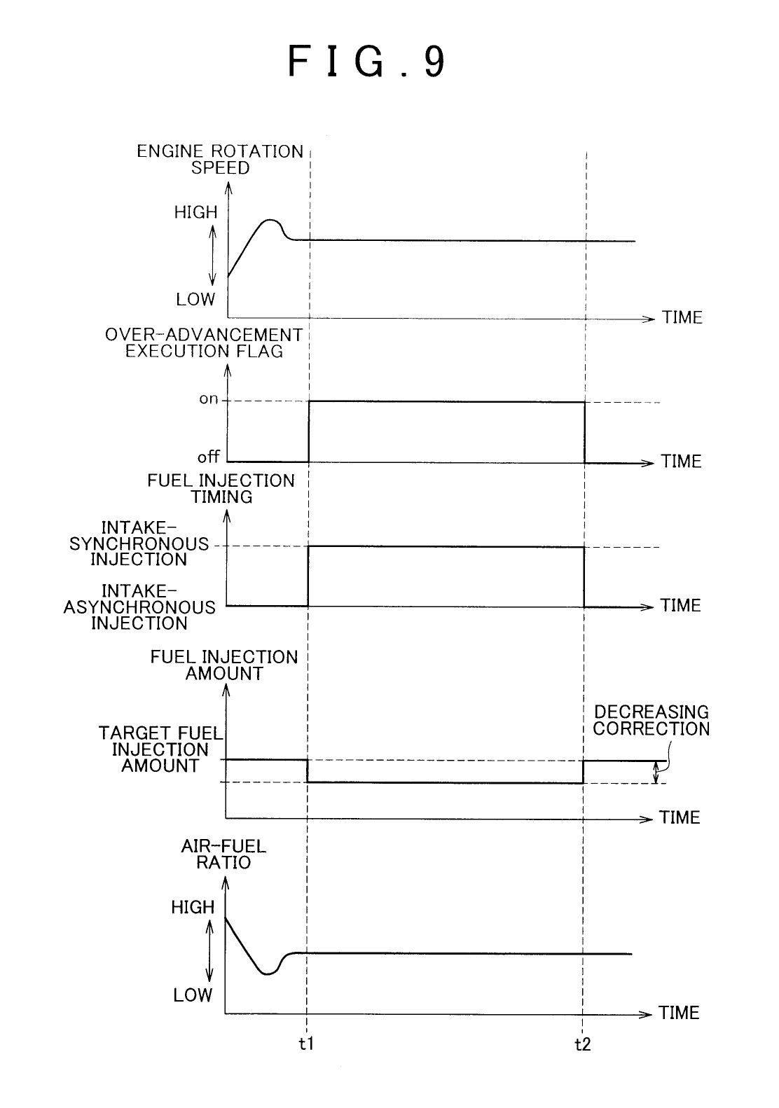

Therefore, in the fuel deposit reduction control of this embodiment, the ECU 20, as shown in FIG. 9, switches the fuel injection timing during the over-advanced state of the ignition timing (t1 to t2 in FIG. 9) to the timing of the intake-synchronous injection, and performs the decreasing correction of the fuel injection amount.

In this case, as the port fuel deposit decreases in amount, an increase in the in-cylinder fuel deposit becomes a concern, but the in-cylinder fuel deposit can be removed (evaporated and burned) by over-advancing the ignition timing. As a result, both the in-cylinder fuel deposit and the port fuel deposit decrease.

Incidentally, as the port fuel deposit in addition to the in-cylinder fuel deposit is used for the combustion, there arises a concern of the fluctuations of the air-fuel ratio and the torque becoming large. However, in this embodiment, the ECU 20 performs the decreasing correction of the fuel injection amount at the time of the over-advancement of the ignition timing, factoring in the decrease in the in-cylinder fuel deposit and the decrease in the port fuel deposit.

If the fuel injection amount and the fuel injection timing during the over-advanced state of the ignition timing are controlled as described above, the fuel injection amount can be further decreased without changing the torque generated by the internal combustion engine 1. Hence, the fuel economy can be further improved, and the unburned fuel components amount discharged from each cylinder 2 can be further decreased.

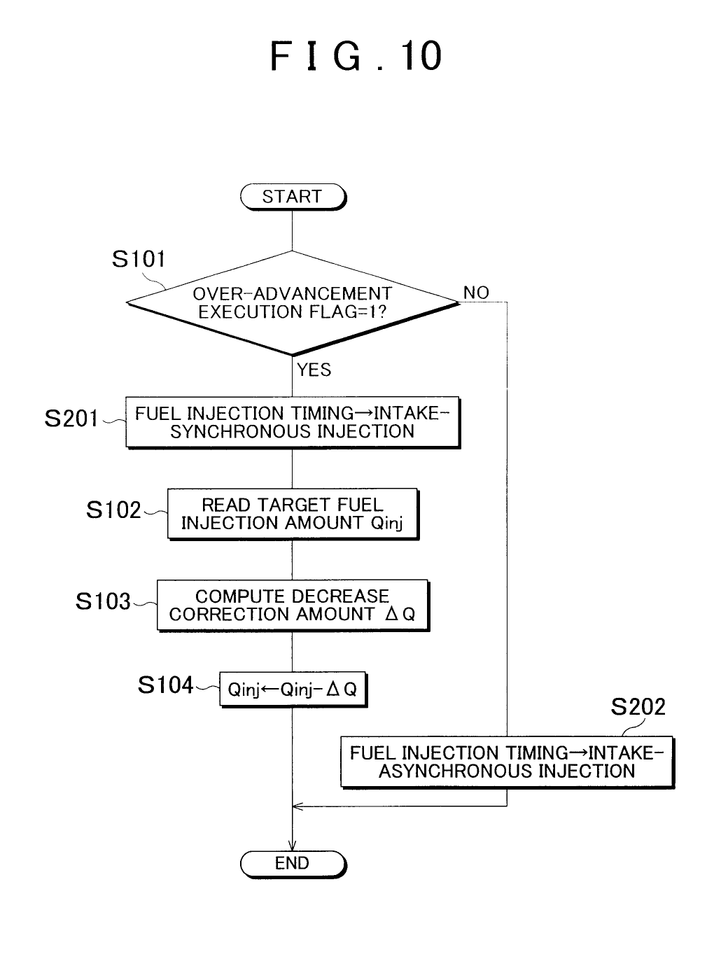

Next, an execution procedure of the fuel deposit reduction control in this embodiment will be described with reference to FIG. 10. FIG. 10 is a flowchart showing a fuel injection amount correction routine performed when the fuel deposit reduction control is executed. In the flowchart in FIG. 10, the processes substantially the same as those in the fuel injection amount correction routine (see FIG. 6) of the first embodiment are represented by the same reference characters.

In the fuel injection amount correction routine shown in FIG. 10, if determining in S101 that the value of the over-advancement execution flag is “1”, the ECU 20 executes the process of S201, in which the ECU 20 sets the fuel injection timing to the intake-synchronous injection. Subsequently in S102 to S104, the ECU 20 performs the decreasing correction of the target fuel injection amount Qinj. At that time, the ECU 20 determines a decrease correction amount ΔQ by factoring in the port fuel deposit amount in addition to the in-cylinder fuel deposit amount.

On the other hand, if it is determined in S101 that the value of the over-advancement execution flag is not “1”, the ECU 20 executes the process of S202, in which the ECU 20 sets the fuel injection timing to the intake-asynchronous injection.

As the ECU 20 thus executes the fuel injection amount correction routine shown in FIG. 10, correction means and injection control means are realized. As a result, the fuel economy can be further improved, and the unburned fuel components amount discharged from the cylinders 2 can be further decreased.

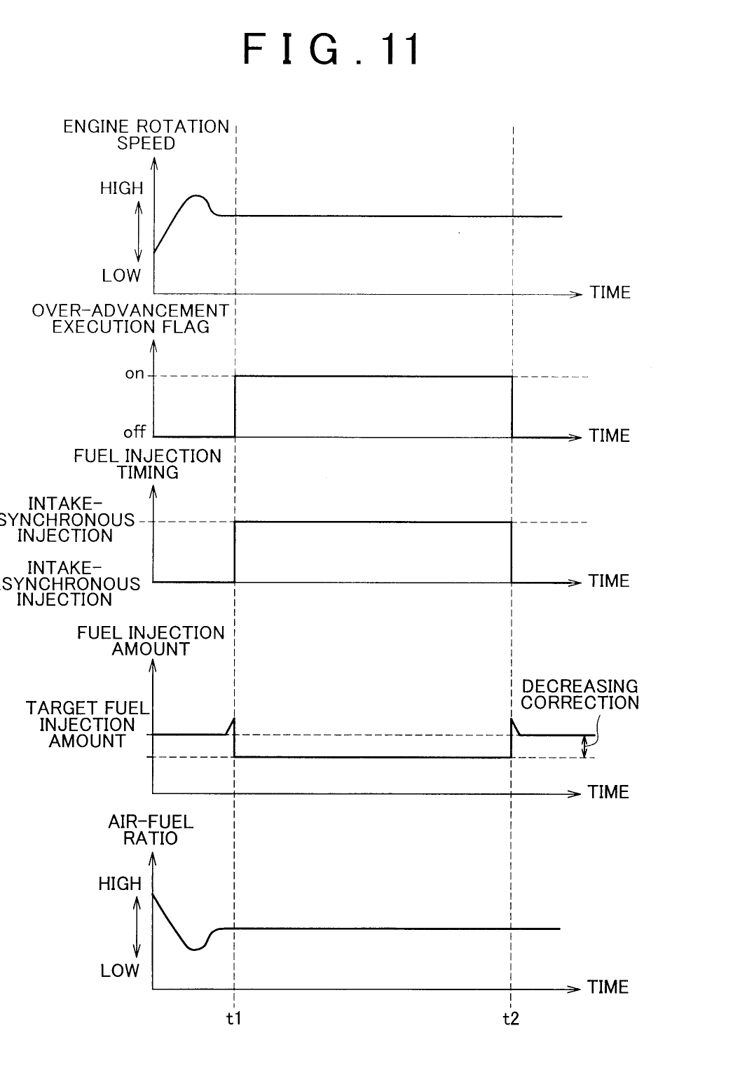

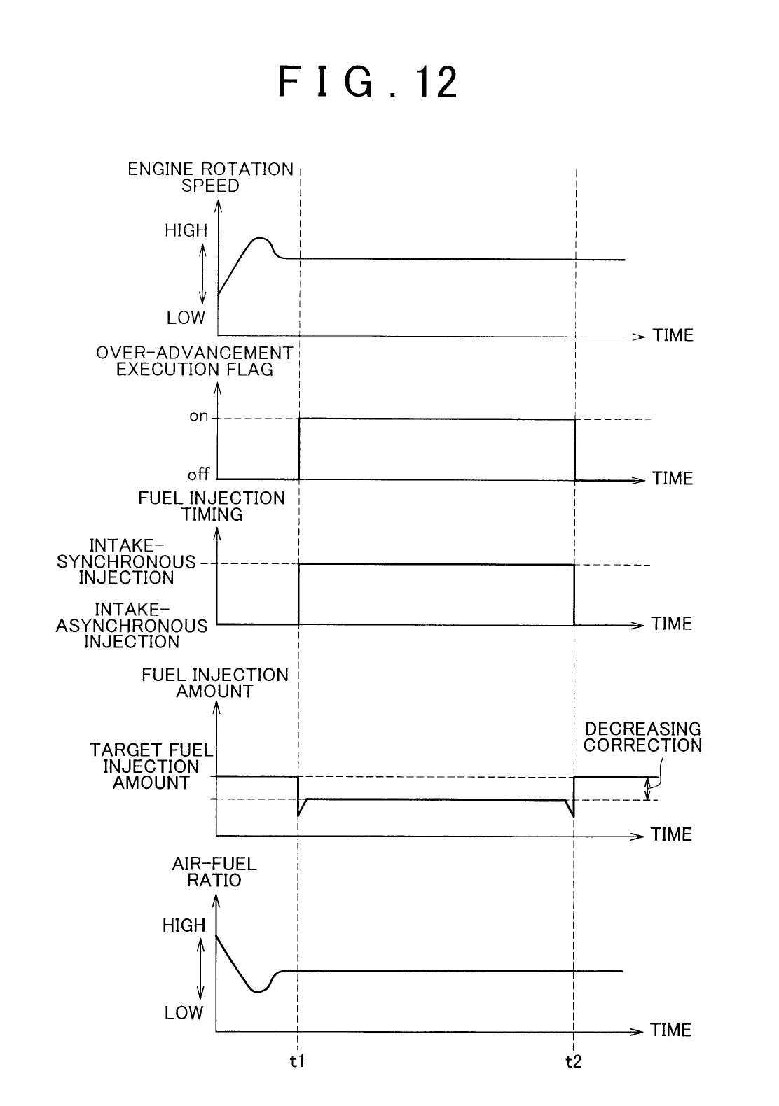

It is to be noted herein that the in-cylinder fuel deposit amount and the port fuel deposit amount sometimes temporarily increase or decrease at the transition time at which the fuel injection timing is switched from the intake-asynchronous injection to the intake-synchronous injection or at the transition time at which the fuel injection timing is switched from the intake-synchronous injection to the intake-asynchronous injection. In such a case, the amount of fuel used for combustion (the contributing-to-combustion fuel amount) in each cylinder 2 also temporarily increases or decreases. To cope with this, the target fuel injection amount may be temporarily increased or decreased at the time of switching the fuel injection timing, as shown in FIG. 11 or 12.

According to these methods, the temporary increase or decrease of the contributing-to-combustion fuel amount at the switching of the fuel injection timing will be prevented.

What is claimed is:

1. A control system for a spark ignition type internal combustion engine, comprising:
an over-advancement device that advances an ignition timing of the internal combustion engine beyond an MBT; and
a correction device that performs a decreasing control of a fuel injection amount of a fuel injection valve of the internal combustion engine when the ignition timing is advanced beyond the MBT by the over-advancement device.

2. The control system according to claim 1, wherein the correction device changes the fuel injection amount based on an amount of advancement of the ignition timing.

3. The control system according to claim 2, wherein the correction device decreases the fuel injection amount as the amount of advancement of the ignition timing increases.

4. The control system according to claim 1, wherein the correction device decreases the fuel injection amount based on an amount of fuel that deposits in a cylinder of the internal combustion engine.

5. The control system according to claim 1, wherein the over-advancement device advances the ignition timing beyond the MBT in at least one of a case where the internal combustion engine is cold-started, a case where the internal combustion engine is in a warming-up operation state, a case where an actually measured value of an amount of fuel that deposits in a cylinder of the internal combustion engine exceeds a predetermined value, and a case where an estimated value of the amount of fuel that deposits in a cylinder of the internal combustion engine exceeds a predetermined value.

6. The control system according to claim 1, further comprising an injection control device that switches a fuel injection timing of the fuel injection valve to a timing synchronous with an intake stroke of the internal combustion engine when the ignition timing is advanced beyond the MBT by the over-advancement device,
wherein the fuel injection valve injects fuel into an intake port of the internal combustion engine.

7. The control system according to claim 6, wherein the correction device changes the fuel injection amount based on a change in an amount of fuel that deposits in a cylinder of the internal combustion engine and a change in an amount of fuel that deposits in the intake port, in a transition period in which the fuel injection timing of the fuel injection valve is switched to the timing synchronous with the intake stroke of the internal combustion engine.

8. A control method for a spark ignition type internal combustion engine, comprising:
advancing an ignition timing of the internal combustion engine beyond an MBT; and
performing a decreasing control of a fuel injection amount of a fuel injection valve of the internal combustion engine when the ignition timing is advanced beyond the MBT.

9. The control method according to claim 8, wherein the fuel injection amount is changed based on an amount of advancement of the ignition timing.

10. The control method according to claim 9, wherein the fuel injection amount is decreased as the amount of advancement of the ignition timing increases.

11. The control method according to claim 8, wherein the fuel injection amount is decreased based on an amount of fuel that deposits in a cylinder of the internal combustion engine.

12. The control method according to claim 8, wherein the ignition timing is advanced beyond the MBT in at least one of a case where the internal combustion engine is cold-started, a case where the internal combustion engine is in a warming-up operation state, a case where an actually measured value of an amount of fuel that deposits in a cylinder of the internal combustion engine exceeds a predetermined value, and a case where an estimated value of the amount of fuel that deposits in a cylinder of the internal combustion engine exceeds a predetermined value.

13. The control method according to claim 8, further comprising switching a fuel injection timing of the fuel injection valve to a timing synchronous with an intake stroke of the internal combustion engine when the ignition timing is advanced beyond the MBT by the over-advancement device,
wherein fuel is injected into an intake port of the internal combustion engine.

14. The control method according to claim 13, wherein the fuel injection amount is changed based on a change in an amount of fuel that deposits in a cylinder of the internal combustion engine and a change in an amount of fuel that deposits in the intake port, in a transition period in which the fuel injection timing of the fuel injection valve is switched to the timing synchronous with the intake stroke of the internal combustion engine.

15. A control system for a spark ignition type internal combustion engine, comprising:
over-advancement means for advancing an ignition timing of the internal combustion engine beyond an MBT; and
correction means for performing a decreasing control of a fuel injection amount of a fuel injection valve of the internal combustion engine when the ignition timing is advanced beyond the MBT by the over-advancement means.
